(19) United States
(12) Patent Application Publication
(10) Pub. No.: US 2024/0323220 A1
(43) Pub. Date: Sep. 26, 2024

(54) Method for Determining Message Decoding Strategy and Apparatus

(71) Applicant: Dbappsecurity Co.,Ltd, Hangzhou (CN)

(72) Inventors: Tingjia PAN, Hangzhou (CN); Jing XU, Hangzhou (CN); Jiakun FENG, Hangzhou (CN)

(21) Appl. No.: 18/540,907

(22) Filed: Dec. 15, 2023

(30) Foreign Application Priority Data
Mar. 22, 2023 (CN) 202310288795.X

(51) Int. Cl. H04L 9/40

(52) U.S. Cl. CPC H04L 63/1433; H04L 63/0245; H04L 63/1416

(57) ABSTRACT

The present disclosure discloses a method for determining a message decoding strategy and apparatus, related to the field of message decoding. After the message is acquired, the message is inputted to a preset machine learning model to determine the type of the message and the decoding strategy of the message. In response to the message being a normal message, the message is decoded based on the obtained decoding strategy and the message is released; in response to the message being a malicious message, the message is rejected, and the preset machine learning model is obtained by training multiple normal messages and malicious messages in advance. Firstly, the type of message and the decoding strategy needed are determined by machine learning model, which effectively reduces the memory occupation of the system and improves the parsing and decoding efficiency of the message.

### TECHNICAL FIELD

The present disclosure relates to the technical field of message decoding, and in particular to a method for determining a message decoding strategy and apparatus.

### BACKGROUND

After the web application firewall of the server receives Hyper Text Transfer Protocol (abbreviated as HTTP) message from other devices, the security engine in the firewall will parse the message according to the preset parsing and decoding mode. However, due to the different formats of different messages and the different processing modes of different servers for the same message, the parsing and decoding modes required by different servers are different, resulting in a single security engine cannot be applied to all types of servers, and attackers are easy to write attack messages according to the differences of parsing and decoding modes between servers and security engines. In order to solve the above-mentioned technical problems, the related art usually sends all the parsing and decoding methods to the security engine. In response to the security engine parses and decodes the message, it will use all the parsing and decoding methods to parse and decode the message as many times as possible. However, the method consumes memory resources and performance, and with the increase of server types and the limitation of the performance of the server where the firewall is located, it cannot be applied to all types of servers.

### SUMMARY

At least some embodiments of the present disclosure provides a method for determining a message decoding strategy and apparatus, which does not require a security engine to execute multiple different types of decoding strategies of the message. In response to the message being a malicious message, there is no need to implement decoding strategy; in response to the message being a normal message, the best decoding strategy can be directly determined, and the decoding strategy only needs to be executed once, which effectively reduces the memory occupation of the system and improves the parsing and decoding efficiency of the message.

In order to solve the above-mentioned technical problems, the present disclosure provides a method for determining a message decoding strategy, including:
a message to be tested is acquired;
the message to be tested is inputted to a preset machine learning model to determine a type of the message to be tested and a decoding strategy of the message to be tested, wherein the preset machine learning model is trained by a preset number of a normal message and a preset number of a malicious message in advance;
the message to be tested is decoded based on the decoding strategy and the message to be tested is released in response to the message to be tested being the normal message;
the message to be tested is rejected in response to the message to be tested being the malicious message.

Optionally, before the message to be tested is inputted to the preset machine learning model, the method further includes:
the message to be tested is determined whether contains a feature indicating an attack on a server;
in response to the message to be tested not containing the feature indicating the attack on the server, a step of inputting the message to be tested to the preset machine learning model is executed;
in response to the message to be tested containing the feature indicating the attack on the server, the message to be tested is determined as the malicious message.

Optionally, before the message to be tested is decoded based on the decoding strategy, the method further includes:
a current security engine is determined whether contains the decoding strategy;
in response to the current security engine containing the decoding strategy, a step of decoding the message to be tested is executed based on the decoding strategy;
in response to the current security engine not containing the decoding strategy, the decoding strategy is loaded into the current security engine, and the step of decoding the message to be tested is executed based on the decoding strategy.

Optionally, the method further includes:
a decoding strategy corresponding to the message to be tested obtained by the preset machine learning model is stored into a preset strategy library;
all the decoding strategies in the preset strategy library are loaded into the current security engine periodically.

Optionally, the decoding strategy corresponding to the message to be tested obtained by the preset machine learning model is stored into the preset strategy library includes:
the decoding strategy corresponding to the message to be tested is determined whether exists in the preset strategy library;
in response to the decoding strategy corresponding to the message to be tested existing in the preset strategy library, a decoding strategy originally stored in the preset strategy library is covered with a decoding strategy currently obtained by the preset machine learning model.

Optionally, the decoding strategy of the message to be tested is determined in the preset machine learning model includes:
a receiving path corresponding to the message to be tested is determined;
request line information in the message to be tested and request body information in the message to be tested are determined;
identifying string information of the message to be tested is determined based on the request line information and the request body information;
the decoding strategy of the message to be tested is determined based on the receiving path, the request line information, the request body information and the identifying string information.

Optionally, the receiving path corresponding to the message to be tested is determined includes:
the receiving path is determined based on an Uniform Resource Identifier (URI) of the message to be tested and a request parameter of the message to be tested.

Optionally, after the message to be tested is inputted to the preset machine learning model, the method further includes:
in response to the preset machine learning model failing to determine the type of the message to be tested and the decoding strategy of the message to be tested, the message to be tested is decoded N times based on N decoding strategies contained in the security engine to obtain N decoding results;
the feature indicating the attack on the server is determined whether exists in the N decoding results;
in response to the feature indicating the attack on the server existing in the N decoding results, the message to be tested is rejected;
in response to the feature indicating the attack on the server not existing in the N decoding results, the message to be tested is released.

Optionally, in response to the message to be tested being a multi-layer nested message, the type of the message to be tested and the decoding strategy of the message to be tested are determined includes:
a decoding strategy corresponding to each layer nesting of the message to be tested is determined based on an order from outside to inside;
the corresponding decoding strategy is executed based on a nested order of each layer.

The present disclosure provides an apparatus for determining a message decoding strategy, including:
a memory, configured to store a computer program;
a processor, configured to execute the computer program, wherein the processor implements the method of determining a message decoding strategy, wherein the method comprises the following steps:
acquiring a message to be tested;
inputting the message to be tested to a preset machine learning model to determine a type of the message to be tested and a decoding strategy of the message to be tested, wherein the preset machine learning model is trained by a preset number of a normal message and a preset number of a malicious message in advance;
decoding the message to be tested based on the decoding strategy and releasing the message to be tested in response to the message to be tested being the normal message;
rejecting the message to be tested in response to the message to be tested being the malicious message.

The present disclosure provides a method for determining a message decoding strategy and apparatus, related to the field of message decoding. After the message is acquired, the message is inputted to a preset machine learning model to determine the type of the message and the decoding strategy of the message. In response to the message being a normal message, the message is decoded based on the obtained decoding strategy and the message is released; in response to the message being a malicious message, the message is rejected, and the preset machine learning model is obtained by training multiple normal messages and malicious messages in advance. Firstly, the type of message and the decoding strategy needed are determined by machine learning model, and the security engine does not need to execute different decoding strategies for the message many times, in response to the message being a malicious message, there is no need to implement decoding strategy; in response to the message being a normal message, the best decoding strategy can be directly determined, and the decoding strategy only needs to be executed once, which effectively reduces the memory occupation of the system and improves the parsing and decoding efficiency of the message.

### BRIEF DESCRIPTION OF THE DRAWINGS

FIG. 1 is a flowchart of a method for determining a message decoding strategy according to an embodiment of the present disclosure;

FIG. 2 is an execution flowchart of a message decoding strategy according to an embodiment of the present disclosure;

FIG. 3 is a schematic structural diagram of an apparatus for determining a message decoding strategy according to an embodiment of the present disclosure.

### DETAILED DESCRIPTION

The core of the present disclosure is to provide a method for determining a message decoding strategy and an apparatus, which does not require a security engine to execute multiple different types of decoding strategies for the message. In response to the message being a malicious message, there is no need to implement decoding strategy; in response to the message being a normal message, the best decoding strategy can be directly determined, and the decoding strategy only needs to be executed once, which effectively reduces the memory occupation of the system and improves the parsing and decoding efficiency of the message.

In order to make the objects, technical aspects and advantages of the embodiments of the disclosure clearer, the technical aspects of the embodiments of the disclosure will be clearly and completely described below in conjunction with the accompanying drawings in the embodiments of the disclosure, and it will be apparent that the described embodiments are part of, but not all of, the embodiments of the disclosure. Based on the embodiments in the present disclosure, all other embodiments obtained by those of ordinary skill in the art without making creative efforts are within the scope of protection of the present disclosure.

The application in the server is usually equipped with a firewall. When the server receives the message, it first needs to process the message through the security engine of the firewall, specifically, parse and decode the message to make it become a format easy to read by the server, and at the same time, parse out whether the message is a malicious message in the process to avoid releasing the malicious message and causing the server to be attacked. The specific parsing and decoding mode of the security engine is to construct the parts in the message that need to be detected into a data structure of key (detection part) value (detection part value) pair, and this data structure is the parsed message. However, in the practical application, not only the format of different messages is different, but also the same message may be inputted to different servers, and different servers have different processing methods for the same message, so different servers need different parsing and decoding methods. Based on this, the attacker can construct a special structure message to attack the server according to the parsing and decoding difference between the server and the security engine. When the security engine parses the message with this special structure, it may not be able to parse the attack characteristics of the message, which leads to the message bypassing the detection of the firewall and attacking the server. Therefore, it is necessary for the security engine in the firewall to take into account all different parsing and decoding methods at the same time to avoid the situation that the message cannot be parsed.

In the related art, all the commonly used parsing and decoding modes are written into the security engine in advance. In order to avoid attack bypass, in response to a message being received, the security engine will carry out different kinds of parsing and decoding modes as much as possible, that is, all the parsing and decoding modes are carried out once to obtain the corresponding parsing results of various modes, and these results are inputted to the detection module to detect whether the attack features are included in the message to obtain the best parsing result of the message, which is compatible with different servers as much as possible. It specifically comprises the following steps:
(1) Receiving a message;
(2) Performing all parsing and decoding operations on the message to generate all possible results;
(3) Inputting all the possible results to the detection module of the firewall for detection, and each possible result corresponds to a detection results;
(4) Determining whether the message is normal based on all the detection results. If the message is normal, release the message; otherwise, stop the message.

In step (2), all parsing and decoding operations refer to the parsing and decoding operations of some commonly used messages obtained based on the experience of staff, such as JSON parsing, XML parsing, URL decoding, Base64 decoding and other parsing and decoding methods. Because different servers are written in different languages, and the same language also has different parsing and decoding libraries, there are great differences between parsing operations such as JSON and XML, so it is necessary to carry out various types of parsing and decoding methods as much as possible and list all possible results.

To sum up, although the related art can effectively parse various forms of messages and avoid attacking messages bypassing firewalls, it will occupy a lot of system memory and affect the performance of the server because it needs to perform many different types of parsing and decoding operations on the message every time it is received.

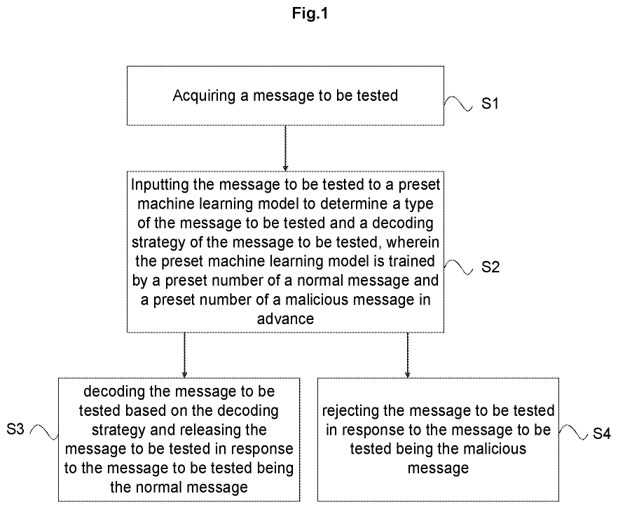

In order to solve the above-mentioned technical problems, as shown in FIG. 1, FIG. 1 is a flowchart of a method for determining a message decoding strategy provided by the present disclosure, including:
Step 1: a message to be tested is acquired;
Step 2: the message to be tested is inputted to a preset machine learning model to determine a type of the message to be tested and a decoding strategy of the message to be tested, wherein the preset machine learning model is trained by a preset number of a normal message and a preset number of a malicious message in advance;
Step 3: the message to be tested is decoded based on the decoding strategy and the message to be tested is released in response to the message to be tested being the normal message;
Step 4: the message to be tested is rejected in response to the message to be tested being the malicious message.

Security engine is actually a virtual apparatus, which refers to the task that the processor parses and decodes messages through a specific algorithm. This task is called the security engine, which reduces the memory occupied by the security engine, that is, reduces the memory occupied by the processor. In order to distinguish other tasks performed by the processor, the security engine is still called the security engine, and the same applies to other virtual structures such as modules or models below.

In order to reduce the times of parsing and decoding by the security engine and reduce the amount of memory occupied by the system, in this disclosure, the understanding and parsing ability of the security engine is raised to the eighth business layer, and the best parsing and decoding mode (i.e. decoding strategy, hereinafter referred to as decoding strategy) corresponding to various messages is determined through a machine learning model, so that the security engine can only execute the strategy once, thus replacing multiple decoding strategies that the security engine originally needs to execute. Specifically, after other devices send a message to the server, in response to the security engine (in fact, the processor) receiving the message, it first does not parse and decode the message, but first sends the message to the machine learning model. The machine learning model determines the most appropriate decoding strategy of the message on the server based on the format of the message itself and the type of the server to which the message points, and at the same time determines whether the message is an attack message based on the content contained in the message (such as data frame content, frame header or frame tail and other characteristic information). If it is determined that the message is an attack message, it will not be parsed and decoded, but will be directly rejected. If it is a normal message, it will be strategized and released according to the best decoding strategy given by the machine learning model. It can be seen that after the introduction of the machine learning model, the message can be effectively processed only by executing the decoding strategy once at most, which effectively reduces the system memory occupation of the security engine.

When training the machine learning model, all kinds of original messages received by the server are taken as the training set of the machine learning model, which need to include messages of various formats, and need to be applied to different servers for training (it can also be trained on one server, and then the server type is determined according to the servers pointed by different messages). It is also necessary to ensure that messages of various formats contain multiple normal messages and multiple attack messages, which are trained to the machine learning model as black and white samples respectively. These samples are stored in a specific directory for machine learning model to obtain, and two black-and-white samples, normal message and attack message, are stored separately in different directories.

In response to determining the decoding strategy, investigate based on the computational difficulty of machine learning model and the complexity of decoding strategy, different decoding strategies are treated differently. For simple decoding strategies, it is necessary to build and apply them quickly. Further, these simple decoding strategies can be implemented in the preset forwarding engine to save the performance of the security engine. For complex decoding strategies, it needs to be carried out in the security engine.

To sum up, after obtaining the message to be tested, the message to be tested is inputted to a preset machine learning model to determine the type and decoding strategy of the message to be tested. In response to the message to be tested being a normal message, the message to be tested is decoded based on the decoding strategy, and the message to be tested is released. In response to the message to be tested is a malicious message, the message to be tested is rejected. The preset machine learning model is trained by a preset number of normal messages and malicious messages in advance. Firstly, the type of message to be tested and the decoding strategy needed are determined by machine learning model, and the security engine does not need to execute different decoding strategies for the message many times. In response to the message being a malicious message, there is no need to implement decoding strategy; in response to the message being a normal message, the best decoding strategy can be directly determined, and the decoding strategy only needs to be executed once, which effectively reduces the memory occupation of the system and improves the parsing and decoding efficiency of the message.

On the basis of the above embodiments:

As a preferred embodiment, before the message to be tested is inputted to the preset machine learning model, the method further includes:
the message to be tested is determined whether contains a feature indicating an attack on a server;
in response to the message to be tested not containing the feature indicating the attack on the server, a step of inputting the message to be tested to the preset machine learning model is executed;
in response to the message to be tested containing the feature indicating the attack on the server, the message to be tested is determined as the malicious message.

In order to simply judge whether the message is normal or not, in this disclosure, considering that the malicious message attacking the server usually has some obvious features, such as a specific string or an abnormal path pointed to by the message, in order to simply screen out the obviously malicious message and reduce the calculation amount of the machine learning model, a detection module specially taken for detecting whether the message is malicious is set in the processor of the server, and some common attack characteristics are stored in advance so that the detection module can be taken for comparison and reference. In response to the server receiving the message, the detection module firstly detects the message, if the message has such obvious features, it directly judges that the message is a malicious message and rejects it without subsequent detection, and the specific detection mode can be to detect whether the message has a string as in the above-mentioned example or whether the path pointed by the message is a normal path, etc. This disclosure does not limit this; if the message does not have the above-mentioned obvious features, it is output to the machine learning model for further detection to accurately judge whether the message is a malicious message. Based on this, before inputting the message to the machine learning model, we first judge whether the message has attack features, and we can simply judge whether the message is normal.

In addition, because attackers are constantly looking for new bypass ways to attack the server, the structure of malicious messages and attack messages will also change constantly. In addition, the server and middleware actually used will also change, which will lead to the change of decoding strategy. Therefore, in response to the server or middleware being replaced, and new structure or new type of message is found, it is necessary to detect the message, recursively decode the message, and judge whether it has attack characteristics.

As a preferred embodiment, before the message to be tested is decoded based on the decoding strategy, the method further includes:
a current security engine is determined whether contains the decoding strategy;
in response to the current security engine containing the decoding strategy, a step of decoding the message to be tested is executed based on the decoding strategy;
in response to the current security engine not containing the decoding strategy, the decoding strategy is loaded into the current security engine, and the step of decoding the message to be tested is executed based on the decoding strategy.

In order to improve the efficiency of parsing and decoding, in this disclosure, it is considered that the security engine needs to use the decoding strategy, if the security engine itself not containing the decoding strategy, then when the machine learning model determines the decoding strategy corresponding to the message to be measured, the security engine needs to decode the message to be measured from the complete decoding strategy temporarily inputted by the machine learning model. Because of the large amount of data of the complete decoding strategy, if the decoding strategy inputted by the machine learning model is needed when decoding the message every time, the decoding efficiency will be reduced because of the need to consume the time of data transmission. Based on this, an identifier can be set for each decoding strategy. After the machine learning model determines the decoding strategy of the message to be measured, the decoding strategy is directly loaded into the security engine to make it become a part of the security engine. In the subsequent use process, in response to the machine learning model determining that the decoding strategy of a certain message already exists in the security engine, it does not need to send the decoding strategy to the security engine again, but generates an identifier. Based on the identifier, it can be known which decoding strategy needs to be used to decode the message. To sum up, by loading the decoding strategy into the security engine, although there are a large number of decoding strategies in the security engine, the actual decoding strategy still needs to be executed according to the instructions of the machine learning model, and the execution times are only once, so it will not affect the memory occupation and improve the decoding efficiency.

As a preferred embodiment, the method further includes:
a decoding strategy corresponding to the message to be tested obtained by the preset machine learning model is stored into a preset strategy library;
all the decoding strategies in the preset strategy library are loaded into the current security engine periodically.

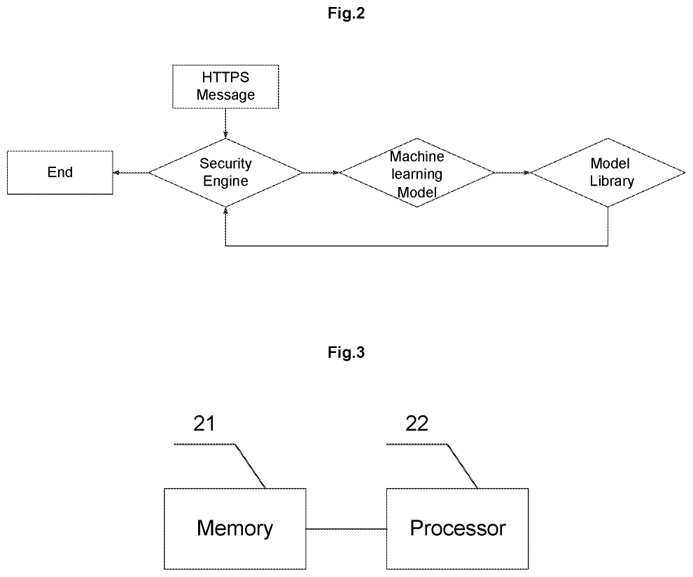

In order to further improve the efficiency, in this disclosure, the decoding strategies determined by the machine learning model can be stored in a preset strategy library, such as a specific path. Considering that the machine learning model will constantly determine a more perfect and efficient decoding strategy based on the messages received by the server, and for the same strategy, the post-determination is more perfect than the previous determination. If there is a new decoding strategy with higher efficiency, the old decoding strategy with lower efficiency is still used, which is not conducive to improving efficiency. Therefore, as shown in FIG. 2, which is an execution flow chart of a message decoding strategy provided in this disclosure. All decoding strategies in the preset strategy library will be loaded into the security engine every once in a while. If the loaded decoding strategies have the same decoding strategy in the security engine, the original decoding strategy in the security engine can be overwritten. Based on this, the efficiency can be further improved.

As a preferred embodiment, the decoding strategy corresponding to the message to be tested obtained by the preset machine learning model is stored into the preset strategy library includes:
the decoding strategy corresponding to the message to be tested is determined whether exists in the preset strategy library;
in response to the decoding strategy corresponding to the message to be tested existing in the preset strategy library, a decoding strategy originally stored in the preset strategy library is covered with a decoding strategy currently obtained by the preset machine learning model.

In order to obtain a continuously perfect decoding strategy, in this disclosure, because the machine learning model will constantly determine a new decoding strategy based on the messages received by the server, because of the learning features of the machine learning model, the decoding strategy determined later must be more perfect than the same decoding strategy determined previously, so the same decoding strategy obtained this time by the preset machine learning model can overwrite the version previously stored in the preset strategy library. At the same time, in order to avoid the efficiency degradation caused by loading the new decoding strategy into the security engine every time, the new decoding strategy can be loaded into the security engine based on the above periodic loading. By overwriting the old decoding strategy, we can not only get a continuous improvement of the new decoding strategy, but also avoid too much storage space occupied by too many decoding strategies.

As a preferred embodiment, the decoding strategy of the message to be tested is determined in the preset machine learning model includes:
a receiving path corresponding to the message to be tested is determined;
request line information in the message to be tested and request body information in the message to be tested are determined;
identifying string information of the message to be tested is determined based on the request line information and the request body information;
the decoding strategy of the message to be tested is determined based on the receiving path, the request line information, the request body information and the identifying string information.

In order to accurately determine the decoding strategy corresponding to the message, in this disclosure, it is necessary to determine based on the acceptance path and the request information in the message. Specifically, in the machine learning model, endpoints are modeled to form an xml data structure, through which various attributes and structures of messages are described. The xml data structure consists of four parts: Endpoint Discovery, Parsing Path Pattern, Format Pattern and String Pattern.

Endpoint discovery is used to identify the path corresponding to the message, because highly similar and identical messages are usually requests to the same endpoint, that is, requests pointing to the same server path. Both the parsing path model and the format pattern are used to describe the data structure of the message itself. Because the parsing ability of the parsing path pattern is limited, the format information of the complete message can be parsed and depicted for the common message, and the format information of a certain part of the message can only be parsed for the unusual message. Based on this, the node names of each nested level and each hierarchy in the message are parsed through the format pattern, and the structure of the message is further parsed and depicted to completely analyze the structure information of the message. If the parsing path pattern has already parsed some packets, the parsing results can be directly used in the format pattern. The string pattern describes the message structure information (usually a string content) obtained after all the above parsing through regular expressions or DFA (Deterministic Finite Automaton). To sum up, by determining the endpoint or receiving path of the message, the server receiving the message can be determined, and then the processing mode of the server to the message can be determined. By determining the structure information of the message, the specific type and structure of the message can be determined, and then the decoding strategy needed for the message can be determined. Combining the results of both, the best decoding strategy for the message on the server can be determined.

In addition, because the decoding strategy generated by the machine learning model is stored in the form of XML data structure files, and it is also transmitted between the machine learning model and the security engine in the form of a file, so that the file should also be stored in a specific path, so that the path corresponds to the actual parsing and decoding task path. Decoding strategies can also be expressed in the form of regular expressions to express the specific types and maturity of decoding strategies and other information for easy to inquire. To sum up, the decoding strategy corresponding to the message can be accurately determined.

As a preferred embodiment, the receiving path corresponding to the message to be tested is determined includes:
the receiving path is determined based on an URI of the message to be tested and a request parameter of the message to be tested.

In order to accurately determine the path of the message, in this disclosure, the request method of the message is the same or the URI (Uniform Resource Identifier) part is the same or completely the same, because different parameters on the same URI are configured to distinguish different endpoints, and the path of the same URI has the same pattern. If the first half of the path of the URI of multiple messages is the same but the basename of the second half changes, it can be explained that these messages are all requests for using one service unit; If they are identical, they can better explain that they are requests for the same endpoint, that is, they point to the same path. Therefore, the receiving path corresponding to the message can be accurately determined by URI and request parameters.

It should be noted that the endpoint is not completely equivalent to the URL (Uniform Resource Locator) in the message, but mainly consists of the path in the request line, the parameters in the request line and the data format in the request body. Because the data types of messages received by the same endpoint are usually the same. Therefore, in response to forming an endpoint, it is necessary to summarize the information such as the path in the request line, the parameters in the request line and the request body, and the data format in the request body, and then aggregate similar messages, record these information formats, and form an endpoint corresponding to these similar messages

As a preferred embodiment, after the message to be tested is inputted to the preset machine learning model, the method further includes:
in response to the preset machine learning model failing to determine the type of the message to be tested and the decoding strategy of the message to be tested, the message to be tested is decoded N times based on N decoding strategies contained in the security engine to obtain N decoding results;
the feature indicating the attack on the server is determined whether exists in the N decoding results;
in response to the feature indicating the attack on the server existing in the N decoding results, the message to be tested is rejected;
in response to the feature indicating the attack on the server not existing in the N decoding results, the message to be tested is released.

In order to accurately judge whether the message is normal, in this disclosure, considering the form and variety of messages, when the machine learning model encounters rare or unseen types of messages, it is difficult for the machine learning model to give the best decoding strategy for such messages. Therefore, in response to encountering this situation, the machine learning model can construct the preliminary unfinished decoding strategy of this message. The security engine does not use the unfinished decoding strategy when decoding the message, but decodes the message one by one based on other completed and mature decoding strategies, and obtains the decoding results of each decoding strategy for the message. If a certain decoding result can reflect the characteristics of attacking the server, it will directly reject the message. Subsequent machine learning models can decode such messages based on various other completed and mature decoding strategies.

For the unfinished decoding strategy, as the number of times the machine learning model encounters this type of message increases, the decoding strategy will gradually improve. It can be set based on the actual effect of the decoding strategy in advance. For example, it can be set based on the iteration times of other decoding strategies. If other decoding strategies usually have good decoding effect after 10 iterations, the decoding strategy after 10 updates and iterations can be determined as the completed decoding strategy, and those less than 10 times can be regarded as unfinished. In combination with other embodiments, when decoding strategies are loaded into the security engine, these unfinished decoding policies are not loaded into the security engine. Based on this, it can accurately judge whether the message is normal or not.

As a preferred embodiment, in response to the message to be tested being a multi-layer nested message, the type of the message to be tested and the decoding strategy of the message to be tested are determined includes:
a decoding strategy corresponding to each layer nesting of the message to be tested is determined based on an order from outside to inside;
the corresponding decoding strategy is executed based on a nested order of each layer.

In order to accurately determine the decoding strategy of the message, in the present disclosure, it is considered that a message may be composed of multiple layers of nesting, and the format of each layer of nesting may be different, so it is necessary to execute a corresponding decoding strategy according to each layer of nesting. Specifically, first of all, it is necessary to determine the style and format of each layer of message nesting from outside to inside. From outside to inside, it usually refers to starting from the outermost layer nesting to the inside. Then, based on the nesting order, the messages are directly decoded by various strategies, which is equivalent to stripping the messages layer by layer to ensure that each layer of messages can be decoded correctly. In addition, it is used for viewing the message content and running state in the machine learning model and the construction process of the model to the decoding strategy through the interactive page. When determining the nesting sequence, the user can edit and control the sequence through the interactive page to actually adjust the sequence of each decoding strategy and the decoding strategy actually used to accurately determine the decoding strategy of the message. Specifically, each decoding strategy can be displayed at the front end of the application firewall, and the main contents are the name of the decoding strategy and the specific implementation method, the data structure type of the request message, the historical times of the message being decoded and other information. Users can actively choose the decoding strategy to be carried out, and can also choose multiple decoding strategies as master strategies and slave strategies, and even build their own decoding strategies and upload them.

As shown in FIG. 3, FIG. 3 is a schematic structural diagram of an apparatus for determining a message decoding strategy provided by the present disclosure, including:
a memory 21, configured to store a computer program;
a processor 22, configured to execute the computer program, wherein the processor implements the step of determining the message decoding strategy.

Each embodiment in this specification is described in a progressive manner, and each embodiment focuses on the differences from other embodiments, and the same and similar parts between the embodiments can be referred to each other. As for the apparatus disclosed in the embodiment, since it corresponds to the method disclosed in the embodiment, the description is relatively simple, and the relevant parts can be described in the method section.

It should also be noted that, in this specification, relational terms such as first and second, etc. are used only to distinguish one entity or operation from another entity or operation, and do not necessarily require or imply that any such actual relationship or order exists between these entities or operations. Moreover, the terms “including”, “including” or any other variation thereof are intended to encompass non-exclusive inclusion, so that a process, method, article or equipment that includes a set of elements includes not only those elements but also other elements that are not explicitly listed or are inherent to such a process, method, article or equipment. In the absence of further limitations, an element defined by the phrase “includes an . . . ” does not preclude the existence of another identical element in the process, method, article or equipment in which the element is included.

The above description of the disclosed embodiments enables those skilled in the related art to practice or use the disclosure. Various modifications to these embodiments will be apparent to those skilled in the related art and the general principles defined herein may be implemented in other embodiments without departing from the spirit or scope of the disclosure. Accordingly the disclosure will not be limited to the embodiments shown herein but is intended to conform to the widest scope consistent with the principles and novel features disclosed herein.

What is claimed is:

1. A method for determining a message decoding strategy, comprising:
acquiring a message to be tested;
inputting the message to be tested to a preset machine learning model to determine a type of the message to be tested and a decoding strategy of the message to be tested, wherein the preset machine learning model is trained by a preset number of a normal message and a preset number of a malicious message in advance;
decoding the message to be tested based on the decoding strategy and releasing the message to be tested in response to the message to be tested being the normal message;
rejecting the message to be tested in response to the message to be tested being the malicious message.

2. The method for determining the message decoding strategy as claimed in claim 1, wherein before inputting the message to be tested to the preset machine learning model, the method further comprises:
determining whether the message to be tested contains a feature indicating an attack on a server;
in response to the message to be tested not containing the feature indicating the attack on the server, executing a step of inputting the message to be tested to the preset machine learning model;
in response to the message to be tested containing the feature indicating the attack on the server, determining the message to be tested as the malicious message.

3. The method for determining the message decoding strategy as claimed in claim 1, wherein before decoding the message to be tested based on the decoding strategy, the method further comprises:
determining whether a current security engine contains the decoding strategy;
in response to the current security engine containing the decoding strategy, executing a step of decoding the message to be tested based on the decoding strategy;
in response to the current security engine not containing the decoding strategy, loading the decoding strategy into the current security engine, and executing the step of decoding the message to be tested based on the decoding strategy.

4. The method for determining the message decoding strategy as claimed in claim 3, the method further comprises:
storing a decoding strategy corresponding to the message to be tested obtained by the preset machine learning model into a preset strategy library;
loading all the decoding strategies in the preset strategy library into the current security engine periodically.

5. The method for determining the message decoding strategy as claimed in claim 4, wherein storing the decoding strategy corresponding to the message to be tested obtained by the preset machine learning model into the preset strategy library comprises:
determining whether the decoding strategy corresponding to the message to be tested exists in the preset strategy library;
in response to the decoding strategy corresponding to the message to be tested existing in the preset strategy library, covering a decoding strategy originally stored in the preset strategy library with a decoding strategy currently obtained by the preset machine learning model.

6. The method for determining the message decoding strategy as claimed in claim 1, wherein determining the decoding strategy of the message to be tested in the preset machine learning model comprises:
determining a receiving path corresponding to the message to be tested;
determining request line information in the message to be tested and request body information in the message to be tested;
determining identifying string information of the message to be tested based on the request line information and the request body information;
determining the decoding strategy of the message to be tested based on the receiving path, the request line information, the request body information and the identifying string information.

7. The method for determining the message decoding strategy as claimed in claim 6, wherein determining the receiving path corresponding to the message to be tested comprises:
determining the receiving path based on an Uniform Resource Identifier (URI) of the message to be tested and a request parameter of the message to be tested.

8. The method for determining the message decoding strategy as claimed in claim 1, wherein after inputting the message to be tested to the preset machine learning model, the method further comprises:
in response to the preset machine learning model failing to determine the type of the message to be tested and the decoding strategy of the message to be tested, decoding the message to be tested N times based on N decoding strategies contained in the security engine to obtain N decoding results;
determining whether the feature indicating the attack on the server exists in the N decoding results;
in response to the feature indicating the attack on the server existing in the N decoding results, rejecting the message to be tested;
in response to the feature indicating the attack on the server not existing in the N decoding results, releasing the message to be tested.

9. The method for determining the message decoding strategy as claimed in claim 1, wherein in response to the message to be tested being a multi-layer nested message, determining the type of the message to be tested and the decoding strategy of the message to be tested comprises:
determining a decoding strategy corresponding to each layer nesting of the message to be tested based on an order from outside to inside;
executing the corresponding decoding strategy based on a nested order of each layer.

10. An apparatus for determining a message decoding strategy, comprising:
a memory, configured to store a computer program;
a processor, configured to execute the computer program, wherein the processor implements the method for determining a message decoding strategy, wherein the method comprises the following steps:
acquiring a message to be tested;
inputting the message to be tested to a preset machine learning model to determine a type of the message to be tested and a decoding strategy of the message to be tested, wherein the preset machine learning model is trained by a preset number of a normal message and a preset number of a malicious message in advance;
decoding the message to be tested based on the decoding strategy and releasing the message to be tested in response to the message to be tested being the normal message;
rejecting the message to be tested in response to the message to be tested being the malicious message.
